(19) United States
(12) Patent Application Publication
(10) Pub. No.: US 2025/0215227 A1
(43) Pub. Date: Jul. 3, 2025

(54) Flame-Retardant and Fire-Resistant Silicone Tape and Preparation Method Thereof

(71) Applicant: Dongguan Longsun Material Technology Co., Ltd., Dongguan City (CN)

(72) Inventors: Hebin Pan, Dongguan City (CN); Zhengxin Tan, Dongguan City (CN); Jun Yang, Dongguan City (CN)

(21) Appl. No.: 18/799,203

(22) Filed: Aug. 9, 2024

(30) Foreign Application Priority Data
Dec. 31, 2023 (CN) 202311860218.X

(51) Int. Cl. C08L 83/06; C08G 77/16; C08G 77/20; C08J 5/04; C08J 5/18; C08K 3/04; C08K 3/36; C08K 5/098; C08K 5/521; C08K 5/5415; C08K 5/5425; H01B 3/46; H01B 3/47

(52) U.S. Cl. CPC C08L 83/06; C08G 77/16; C08G 77/20; C08J 5/043; C08J 5/18; C08K 3/04; C08K 3/36; C08K 5/098; C08K 5/521; C08K 5/5415; C08K 5/5425; H01B 3/465; H01B 3/47; C08J 2383/06; C08J 2383/07; C08K 2201/005; C08K 2201/006; C08K 2201/011; C08L 2201/02; C08L 2203/16; C08L 2203/202; C08L 2205/025

(57) ABSTRACT

Provided are a flame-retardant and fire-resistant silicone tape and a preparation method thereof. The flame-retardant and fire-resistant silicone tape includes the following raw materials in parts by weight: 100 parts to 120 parts of a methyl vinyl silicone rubber, 60 parts to 70 parts of fumed silica, 3 parts to 7 parts of hydroxyl-terminated polydimethylsiloxane, 0.5 parts to 1 part of dioctyl acid phosphate, 2 parts to 6 parts of a vinyl hydroxyl silicone oil, 10 parts to 15 parts of a modified biomass charcoal powder, 0.2 parts to 0.4 parts of zinc stearate, and 5.5 parts to 6.5 parts of a vulcanizing agent.

### CROSS-REFERENCE TO RELATED APPLICATIONS

This patent application claims the benefit and priority of Chinese Patent Application No. 202311860218X filed with the China National Intellectual Property Administration on Dec. 31, 2023, the disclosure of which is incorporated by reference herein in its entirety as part of the present application.

### TECHNICAL FIELD

The present disclosure relates to the technical field of silicone tapes, and in particular relates to a flame-retardant and fire-resistant silicone tape and a preparation method thereof.

### BACKGROUND OF THE INVENTION

Silicone tape is mainly used as an insulating material. For example, the silicone tape is directly wrapped around the outside of a wire when producing wires, or used for wrapping an interface after an electrician repairs the wire.

With the continuous development of society, users in the field of industrial production propose increasingly high requirements for the quality of the silicone tape, especially for its flame-retardant properties. The silicone tape wrapped around fire-resistant cables is prone to becoming brittle and shedding after a fire, which greatly reduces the fire-resistant effect and then causes short circuits, making it difficult to ensure the safe and smooth flow of power and communications in the event of a fire.

In the prior art, various flame retardants are generally added directly to the silicone. However, the direct addition of flame retardants reduces mechanical properties of silicone tapes in most cases.

### SUMMARY OF THE INVENTION

In view of the above technical problems, an object of the present disclosure is to provide a flame-retardant and fire-resistant silicone tape with desirable flame-retardant effect and excellent mechanical properties.

To achieve the object of the present disclosure, the present disclosure adopts the following technical solutions:

The present disclosure provides a flame-retardant and fire-resistant silicone tape, including the following raw materials in parts by weight:

100 parts to 120 parts of a methyl vinyl silicone rubber, 60 parts to 70 parts of fumed silica, 3 parts to 7 parts of hydroxyl-terminated polydimethylsiloxane, 0.5 parts to 1 part of dioctyl acid phosphate, 2 parts to 6 parts of a vinyl hydroxyl silicone oil, 10 parts to 15 parts of a modified biomass charcoal powder, 0.2 parts to 0.4 parts of zinc stearate, and 5.5 parts to 6.5 parts of a vulcanizing agent.

In some embodiments of the present disclosure, the dioctyl acid phosphate (di(2-ethylhexyl)phosphate, CAS: 298-07-7) satisfies both flame retardancy and compatibility.

In some embodiments of the present disclosure, the methyl vinyl silicone rubber is methyl vinyl silicone rubber 110-2, purchased from China National Bluestar (Group) Co., Ltd.

In some embodiments of the present disclosure, the modified biomass charcoal powder is prepared by a process including the following steps:

step A, immersing 100 g to 200 g of biomass charcoal in 1,000 mL of a magnesium hydroxide immersion solution prepared by mixing ammonia water with a magnesium chloride solution for 30 min to 60 min, enabling more magnesium hydroxide to enter internal pores of the biomass charcoal;

step B, adding 20 g to 50 g of γ-aminopropyltriethoxysilane, conducting ultrasonic vibration for 60 min to 120 min to obtain a mixture, subjecting the mixture to separation, and drying at a temperature of 20° C. to 40° C.; and

step C, mixing a resulting dried biomass charcoal and expanded graphite at a weight ratio of (10-15):1, and conducting ultrasonic vibration for 30 min to 60 min to obtain the modified biomass charcoal powder.

In some embodiments of the present disclosure, the biomass charcoal is graphitized biomass charcoal obtained by heating moso bamboo at 280° C./h to 1,300° C. and conducting pyrolysis for 2 h under nitrogen protection. The graphitized biomass charcoal retains the original porous structural characteristics and effectively enhances the stiffness and hardness of a composite.

In some embodiments of the present disclosure, the expanded graphite is expandable graphite produced by Qingdao Baixing Graphite Co., Ltd, China.

In some embodiments of the present disclosure, in step A, the magnesium chloride solution has a concentration of 1 mol/L to 1.5 mol/L, the ammonia water has a concentration of approximately 26 wt %, and a volume ratio of the magnesium chloride solution to the ammonia water is in a range of 100:(1-10).

The γ-aminopropyltriethoxysilane can increase the compatibility between the modified biomass charcoal powder and a silicone system, and also reduce agglomeration of the magnesium hydroxide and expanded graphite in the silicone system.

In some embodiments of the present disclosure, the biomass charcoal has a particle size of 10 meshes to 100 meshes, and the expanded graphite has a particle size of 200 meshes to 300 meshes. Due to the small particle size, there is still a small part of the expanded graphite that can partially enter the pores of the biomass charcoal, while the remaining part enters the silicone system. Most of the magnesium hydroxide enters the pores of the biomass charcoal, while the remaining part enters the silicone system. When encountering fire, the magnesium hydroxide and expanded graphite that enter the silicone system first come into play. As time goes by and the temperature further increases, the expanded graphite entering the pores of the biomass charcoal expands and partially ruptures the pores of the biomass charcoal, thereby releasing the internal magnesium hydroxide, further extending a flame-retardant time and further improving a flame-retardant effect.

In the present disclosure, the flame-retardant and fire-resistant silicone tape prepared by using the modified biomass charcoal powder not only shows a desirable flame-retardant effect but also has a low cost. Compared with the cost of applicant's previous ceramic silicone tape product, the cost of the silicone tape is reduced by about 30%.

In some embodiments of the present disclosure, the fumed silica has a particle size of 25 nm to 35 nm and a specific surface area of 230 m²/g.

In some embodiments of the present disclosure, the vulcanizing agent is a platinum vulcanizing agent, using BPX-800 purchased from Xiamen Baipoxin Industry and Trade Co., Ltd, China.

The present disclosure further provides a method for preparing the flame-retardant and fire-resistant silicone tape mentioned above, including:

step 1, subjecting the methyl vinyl silicone rubber and the fumed silica to first mixing, adding the hydroxyl-terminated polydimethylsiloxane, the dioctyl acid phosphate, the vinyl hydroxyl silicone oil, the modified biomass charcoal powder, and the zinc stearate, conducting second mixing, and then adding the vulcanizing agent, and conducting third mixing to obtain a silicone rubber;

step 2, pressing the silicone rubber to obtain a formed silicone sheet; and

step 3, coating the formed silicone sheet with a glue, pressing a resulting coated

silicone sheet onto a glass fiber cloth, and conducting cutting and packaging to obtain the flame-retardant and fire-resistant silicone tape.

In some embodiments of the present disclosure, the glue is selected from the group consisting of an organic siloxane and a platinum catalyst, and the organic siloxane is preferably an organic siloxane containing methacryloyloxypropyl.

In some embodiments of the present disclosure, the first mixing is conducted at a temperature of 125° C. to 135° C. for 1 h to 3 h, the second mixing is conducted at a temperature of 130° C. to 140° C. for 1 h to 3 h, and the third mixing is conducted at a temperature of 30° C. to 45° C. for 15 min to 30 min; and pressing the silicone rubber is conducted at a temperature of 150° C. to 170° C. and a pressure of 8 MPa to 12 MPa for 1 h to 5 h.

Compared with the prior art, the flame-retardant and fire-resistant silicone tape designed in some embodiments of the present disclosure has the following advantages: in the flame-retardant and fire-resistant silicone tape, biomass charcoal in a modified biomass charcoal powder can be used not only as a filler for silicone but also as a carrier for an inorganic flame retardant, enabling magnesium hydroxide to partially enter a porous structure of the biomass charcoal, thereby greatly reducing an impact of the inorganic flame retardant directly added to the silicone on mechanical properties of materials. γ-aminopropyltriethoxysilane can increase the compatibility between the modified biomass charcoal powder and a silicone system and reduce agglomeration of the magnesium hydroxide and expanded graphite in the silicone system, thereby further enhancing the mechanical properties of the silicone. The expanded graphite can further enhance a flame-retardant effect. In summary, the biomass charcoal in the modified biomass charcoal powder, the magnesium hydroxide, and the expanded graphite cooperate with each other, which greatly improves flame-retardant performance of the silicone tape and ensures the mechanical properties of the silicone tape, and makes the silicone tape low-cost.

### DETAILED DESCRIPTION OF THE INVENTION

In order to further understand the objects, structure, features, and functions of the present disclosure, detailed descriptions are given below with reference to the examples.

### Example 1

A flame-retardant and fire-resistant silicone tape consisted of the following raw materials in parts by weight: 100 parts of a methyl vinyl silicone rubber, 60 parts of fumed silica, 3 parts of hydroxyl-terminated polydimethylsiloxane, 0.5 parts of dioctyl acid phosphate, 2 parts of a vinyl hydroxyl silicone oil, 10 parts of a modified biomass charcoal powder, 0.2 parts of zinc stearate, and 5.5 parts of a vulcanizing agent.

In this example, the modified biomass charcoal powder was prepared by a process as follows:

step A, 100 g of biomass charcoal was immersed in 1,000 mL of a magnesium hydroxide immersion solution prepared by mixing ammonia water with a magnesium chloride solution for 30 min;

step B, 20 g of γ-aminopropyltriethoxysilane was added thereto and then subjected to ultrasonic vibration for 60 min, and a resulting mixture was subjected to separation and dried at 20° C.; and

step C, a resulting dried biomass charcoal and expanded graphite were mixed at a weight ratio of 10:1, and a resulting system was subjected to ultrasonic vibration for 30 min to obtain the modified biomass charcoal powder.

In this example, the biomass charcoal was graphitized biomass charcoal obtained by heating moso bamboo at 280° C./h to 1,300° C. and conducting pyrolysis for 2 h under nitrogen protection.

In this example, in step A, the magnesium chloride solution had a concentration of 1 mol/L, the ammonia water had a concentration of approximately 26 wt %, and a volume ratio of the magnesium chloride solution to the ammonia water was 100:1.

In this example, the biomass charcoal had a particle size of 10 meshes, and the expanded graphite had a particle size of 200 meshes.

In this example, the fumed silica had a particle size of 25 nm and a specific surface area of 230 m²/g.

In this example, the vulcanizing agent was a platinum vulcanizing agent.

A method for preparing the flame-retardant and fire-resistant silicone tape was performed by the following steps:

step 1, the methyl vinyl silicone rubber and the fumed silica were subjected to first mixing, the hydroxyl-terminated polydimethylsiloxane, the dioctyl acid phosphate, the vinyl hydroxyl silicone oil, the modified biomass charcoal powder, and the zinc stearate were added thereto and subjected to second mixing, and then the vulcanizing agent was added thereto and subjected to third mixing to obtain a silicone rubber;

step 2, the silicone rubber was pressed to obtain a formed silicone sheet; and

step 3, the formed silicone sheet was coated with an organic siloxane, a resulting coated silicone sheet was pressed onto a glass fiber cloth, and a resulting product was then subjected to cutting and packaging to obtain the flame-retardant and fire-resistant silicone tape.

In this example, the first mixing was conducted at 125° C. for 3 h, the second mixing was conducted at 130° C. for 3 h, and the third mixing was conducted at 30° C. for 30 min; and the silicone rubber was pressed at 150° C. and 12 MPa for 5 h.

### Example 2

A flame-retardant and fire-resistant silicone tape consisted of the following raw materials in parts by weight: 110 parts of a methyl vinyl silicone rubber, 65 parts of fumed silica, 5 parts of hydroxyl-terminated polydimethylsiloxane, 0.8 parts of dioctyl acid phosphate, 4 parts of a vinyl hydroxyl silicone oil, 12 parts of a modified biomass charcoal powder, 0.3 parts of zinc stearate, and 6.0 parts of a vulcanizing agent.

In this example, the modified biomass charcoal powder was prepared by a process as follows:

step A, 150 g of biomass charcoal was immersed in 1,000 mL of a magnesium hydroxide immersion solution prepared by mixing ammonia water with a magnesium chloride solution for 45 min;

step B, 35 g of γ-aminopropyltriethoxysilane was added thereto and then subjected to ultrasonic vibration for 100 min, and a resulting mixture was subjected to separation and dried at 30° C.; and

step C, a resulting dried biomass charcoal and expanded graphite were mixed at a weight ratio of 12:1, and a resulting system was subjected to ultrasonic vibration for 40 min to obtain the modified biomass charcoal powder.

In this example, the biomass charcoal was graphitized biomass charcoal obtained by heating moso bamboo at 280° C./h to 1,300° C. and conducting pyrolysis for 2 h under nitrogen protection.

In this example, in step A, the magnesium chloride solution had a concentration of 1.3 mol/L, the ammonia water had a concentration of approximately 26 wt %, and a volume ratio of the magnesium chloride solution to the ammonia water was 100:5.

In this example, the biomass charcoal had a particle size of 50 meshes, and the expanded graphite had a particle size of 250 meshes.

In this example, the fumed silica had a particle size of 30 nm and a specific surface area of 230 m²/g.

In this example, the vulcanizing agent was a platinum vulcanizing agent.

A method for preparing the flame-retardant and fire-resistant silicone tape was performed by the following steps:

step 1, the methyl vinyl silicone rubber and the fumed silica were subjected to first mixing, the hydroxyl-terminated polydimethylsiloxane, the dioctyl acid phosphate, the vinyl hydroxyl silicone oil, the modified biomass charcoal powder, and the zinc stearate were added thereto and subjected to second mixing, and then the vulcanizing agent was added thereto and subjected to third mixing to obtain a silicone rubber;

step 2, the silicone rubber was pressed to obtain a formed silicone sheet; and

step 3, the formed silicone sheet was coated with an organic siloxane, a resulting coated silicone sheet was pressed onto a glass fiber cloth, and a resulting product was then subjected to cutting and packaging to obtain the flame-retardant and fire-resistant silicone tape.

In this example, the first mixing was conducted at 130° C. for 2 h, the second mixing was conducted at 135° C. for 2 h, and the third mixing was conducted at 40° C. for 20 min; and the silicone rubber was pressed was conducted at 160° C. and 10 MPa for 3 h.

### Example 3

A flame-retardant and fire-resistant silicone tape consisted of the following raw materials in parts by weight: 120 parts of a methyl vinyl silicone rubber, 70 parts of fumed silica, 7 parts of hydroxyl-terminated polydimethylsiloxane, 1 part of dioctyl acid phosphate, 6 parts of a vinyl hydroxyl silicone oil, 15 parts of a modified biomass charcoal powder, 0.4 parts of zinc stearate, and 6.5 parts of a vulcanizing agent.

In this example, the modified biomass charcoal powder was prepared by a process as follows:

step A, 200 g of biomass charcoal was immersed in 1,000 mL of a magnesium hydroxide immersion solution prepared by mixing ammonia water with a magnesium chloride solution for 60 min;

step B, 50 g of γ-aminopropyltriethoxysilane was added thereto and then subjected to ultrasonic vibration for 120 min, and a resulting mixture was subjected to separation and dried at 40° C.; and

step C, a resulting dried biomass charcoal and expanded graphite were mixed at a weight ratio of 15:1, and a resulting system was subjected to ultrasonic vibration for 60 min to obtain the modified biomass charcoal powder.

In this example, in step A, the magnesium chloride solution had a concentration of 1.5 mol/L, the ammonia water had a concentration of approximately 26 wt %, and a volume ratio of the magnesium chloride solution to the ammonia water was 100:10.

In this example, the biomass charcoal had a particle size of 100 meshes, and the expanded graphite had a particle size of 300 meshes.

In this example, the biomass charcoal was graphitized biomass charcoal obtained by heating moso bamboo at 280° C./h to 1,300° C. and conducting pyrolysis for 2 h under nitrogen protection.

In this example, the fumed silica had a particle size of 35 nm and a specific surface area of 230 m²/g.

In this example, the vulcanizing agent was a platinum vulcanizing agent.

A method for preparing the flame-retardant and fire-resistant silicone tape was performed by the following steps:

step 1, the methyl vinyl silicone rubber and the fumed silica were subjected to first mixing, the hydroxyl-terminated polydimethylsiloxane, the dioctyl acid phosphate, the vinyl hydroxyl silicone oil, the modified biomass charcoal powder, and the zinc stearate were added thereto and subjected to second mixing, and then the vulcanizing agent was added thereto and subjected to third mixing to obtain a silicone rubber;

step 2, the silicone rubber was pressed to obtain a formed silicone sheet; and

step 3, the formed silicone sheet was coated with an organic siloxane, a resulting coated silicone sheet was pressed onto a glass fiber cloth, and a resulting product was then subjected to cutting and packaging to obtain the flame-retardant and fire-resistant silicone tape.

In this example, the first mixing was conducted at 135° C. for 1 h, the second mixing was conducted at 140° C. for 1 h, and the third mixing was conducted at 45° C. for 15 min; and the silicone rubber was pressed at 170° C. and 8 MPa for 1 h.

### Comparative Example 1

Comparative Example 1 differs from Example 2 in that:

A flame-retardant and fire-resistant silicone tape consisted of the following raw materials in parts by weight: 110 parts of a methyl vinyl silicone rubber, 65 parts of fumed silica, 5 parts of hydroxyl-terminated polydimethylsiloxane, 0.8 parts of dioctyl acid phosphate, 4 parts of a vinyl hydroxyl silicone oil, 12 parts of magnesium hydroxide, 12 parts of a modified biomass charcoal powder, 0.3 parts of zinc stearate, and 6.0 parts of a vulcanizing agent.

In this example, the modified biomass charcoal powder was prepared by a process as follows:

step A, 150 g of biomass charcoal was immersed in 1,000 mL of an aqueous solution containing 35 g of γ-aminopropyltriethoxysilane and then subjected to ultrasonic vibration for 100 min, and a resulting mixture was subjected to separation and dried at 30° C.; and

step B, a resulting dried biomass charcoal and expanded graphite were mixed at a weight ratio of 12:1, and a resulting system was subjected to ultrasonic vibration for 40 min to obtain the modified biomass charcoal powder.

In this example, the biomass charcoal had a particle size of 50 meshes, and the expanded graphite had a particle size of 250 meshes.

In this example, the fumed silica had a particle size of 30 nm and a specific surface area of 230 m²/g.

In this example, the vulcanizing agent was a platinum vulcanizing agent.

A method for preparing the flame-retardant and fire-resistant silicone tape was performed by the following steps:

step 1, the methyl vinyl silicone rubber and the fumed silica were subjected to first mixing, the hydroxyl-terminated polydimethylsiloxane, the dioctyl acid phosphate, the vinyl hydroxyl silicone oil, the modified biomass charcoal powder, the magnesium hydroxide, and the zinc stearate were added thereto and subjected to second mixing, and then the vulcanizing agent was added thereto and subjected to third mixing to obtain a silicone rubber;

step 2, the silicone rubber was pressed to obtain a formed silicone sheet; and

step 3, the formed silicone sheet was coated with an organic siloxane, a resulting coated silicone sheet was pressed onto a glass fiber cloth, and a resulting product was then subjected to cutting and packaging to obtain the flame-retardant and fire-resistant silicone tape.

In this example, the first mixing was conducted at 130° C. for 2 h, the second mixing was conducted at 135° C. for 2 h, and the third mixing was conducted at 40° C. for 20 min; and the silicone rubber was pressed at 160° C. and 10 MPa for 3 h.

### Comparative Example 2

Comparative Example 2 differs from Example 2 in that:

The modified biomass charcoal powder was prepared by a process as follows:

step A, 150 g of biomass charcoal was immersed in 1,000 mL of a magnesium hydroxide immersion solution prepared by mixing ammonia water with a magnesium chloride solution for 45 min;

step B, a resulting mixture was subjected to separation and dried at 30° C.; and

step C, a resulting dried biomass charcoal and expanded graphite were mixed at a weight ratio of 12:1, and a resulting system was subjected to ultrasonic vibration for 40 min to obtain the modified biomass charcoal powder.

In this example, in step A, the magnesium chloride solution had a concentration of 1.3 mol/L, the ammonia water had a concentration of approximately 26 wt %, and a volume ratio of the magnesium chloride solution to the ammonia water was 100:5.

### Comparative Example 3

Comparative Example 3 differs from Example 2 in that:

The modified biomass charcoal powder was prepared by a process as follows:

step A, 150 g of biomass charcoal was immersed in 1,000 mL of a magnesium

hydroxide immersion solution prepared by mixing ammonia water with a magnesium chloride solution for 45 min; and

step B, 35 g of γ-aminopropyltriethoxysilane was added thereto and then subjected to ultrasonic vibration for 100 min, and a resulting mixture was subjected to separation and dried at 30° C. to obtain the modified biomass charcoal powder.

In this example, in step A, the magnesium chloride solution had a concentration of 1.3 mol/L, the ammonia water had a concentration of approximately 26 wt %, and a volume ratio of the magnesium chloride solution to the ammonia water was 100:5.

The flame-retardant and fire-resistant silicone tapes prepared in Examples 1 to 3 and Comparative Examples 1 to 3 were tested, wherein a limit oxygen index was tested in accordance with GB/T2406.2-2009; a tensile strength was tested in accordance with GB/T528-2009; a tearing strength was tested in accordance with GB/T529-2008; and a volume resistivity was tested in accordance with GB/T1692-2008.

| | Tensile | Tearing | Volume | Limit |
|---|---|---|---|---|
| | strength | strength | resistivity | oxygen |
| | MPa | kN/m | Ω · cm | index/% |
| Example 1 | 41 | 62 | 6.9 × 10¹⁵ | 29.8 |
| Example 2 | 44 | 64 | 7.3 × 10¹⁵ | 30.4 |
| Example 3 | 42 | 63 | 7.1 × 10¹⁵ | 30.1 |
| Comparative Example 1 | 28 | 49 | 7.0 × 10¹⁵ | 28.9 |
| Comparative Example 2 | 34 | 54 | 6.5 × 10¹⁵ | 27.4 |
| Comparative Example 3 | 41 | 60 | 5.3 × 10¹⁵ | 26.2 |

Result analysis: In Comparative Example 1, magnesium hydroxide was directly added to the silicone matrix; although the flame-retardant performance is slightly reduced, the tensile strength and tearing strength decrease sharply. In Comparative Example 2, the γ-aminopropyltriethoxysilane was not added to the biomass charcoal containing magnesium hydroxide and expanded graphite, causing partial agglomeration of the magnesium hydroxide and expanded graphite, and also affecting the compatibility of biomass charcoal and silicone system, resulting in the decrease in mechanical properties and flame-retardant properties. In Comparative Example 3, no expanded graphite was added, and the tensile strength and tearing strength are slightly reduced, but the flame-retardant performance is greatly reduced.

The present disclosure has been described by the above-mentioned related embodiments, but the above-mentioned embodiments are only examples of implementing the present disclosure. It must be noted that the disclosed embodiments do not limit the scope of the present disclosure. On the contrary, any improvements and modifications made without departing from the spirit and scope of the present disclosure shall fall within the scope of patent protection of the present disclosure.

1. A flame-retardant and fire-resistant silicone tape, comprising the following raw materials in parts by weight: 100 parts to 120 parts of a methyl vinyl silicone rubber, 60 parts to 70 parts of fumed silica, 3 parts to 7 parts of hydroxyl-terminated polydimethylsiloxane, 0.5 parts to 1 part of dioctyl acid phosphate, 2 parts to 6 parts of a vinyl hydroxyl silicone oil, 10 parts to 15 parts of a modified biomass charcoal powder, 0.2 parts to 0.4 parts of zinc stearate, and 5.5 parts to 6.5 parts of a vulcanizing agent.

2. The flame-retardant and fire-resistant silicone tape according to claim 1, wherein the modified biomass charcoal powder is prepared by a process comprising the following steps:
step A, immersing 100 g to 200 g of biomass charcoal in 1,000 mL of a magnesium hydroxide immersion solution for 30 min to 60 min, wherein the magnesium hydroxide immersion solution is prepared by mixing ammonia water with a magnesium chloride solution;
step B, adding 20 g to 50 g of γ-aminopropyltriethoxysilane, conducting ultrasonic vibration for 60 min to 120 min to obtain a mixture, subjecting the mixture to separation, and drying at a temperature of 20° C. to 40° C.; and
step C, mixing a resulting dried biomass charcoal and expanded graphite at a weight ratio of (10-15):1, and conducting ultrasonic vibration for 30 min to 60 min to obtain the modified biomass charcoal powder.

3. The flame-retardant and fire-resistant silicone tape according to claim 2, wherein in step A, the magnesium chloride solution has a concentration of 1 mol/L to 1.5 mol/L, the ammonia water has a concentration of 26 wt %, and a volume ratio of the magnesium chloride solution to the ammonia water is in a range of 100:(1-10).

4. The flame-retardant and fire-resistant silicone tape according to claim 2, wherein the biomass charcoal has a particle size of 10 meshes to 100 meshes, and the expanded graphite has a particle size of 200 meshes to 300 meshes.

5. The flame-retardant and fire-resistant silicone tape according to claim 1, wherein the fumed silica has a particle size of 25 nm to 35 nm and a specific surface area of 230 m²/g.

6. The flame-retardant and fire-resistant silicone tape according to claim 1, wherein the vulcanizing agent is a platinum vulcanizing agent.

7. A method for preparing the flame-retardant and fire-resistant silicone tape according to claim 1, comprising:
step 1, subjecting the methyl vinyl silicone rubber and the fumed silica to first mixing, adding the hydroxyl-terminated polydimethylsiloxane, the dioctyl acid phosphate, the vinyl hydroxyl silicone oil, the modified biomass charcoal powder, and the zinc stearate, conducting second mixing, and then adding the vulcanizing agent, and conducting third mixing to obtain a silicone rubber;
step 2, pressing the silicone rubber to obtain a formed silicone sheet; and
step 3, coating the formed silicone sheet with a glue, pressing a resulting coated silicone sheet onto a glass fiber cloth, and conducting cutting and packaging to obtain the flame-retardant and fire-resistant silicone tape.

8. The method for preparing the flame-retardant and fire-resistant silicone tape according to claim 7, wherein the first mixing is conducted at a temperature of 125° C. to 135° C. for 1 h to 3 h, the second mixing is conducted at a temperature of 130° C. to 140° C. for 1 h to 3 h, and the third mixing is conducted at a temperature of 30° C. to 45° C. for 15 min to 30 min; and pressing the silicone rubber is conducted at a temperature of 150° C. to 170° C. and a pressure of 8 MPa to 12 MPa for 1 h to 5 h.

9. The method for preparing the flame-retardant and fire-resistant silicone tape according to claim 7, wherein the modified biomass charcoal powder is prepared by a process comprising the following steps:
step A, immersing 100 g to 200 g of biomass charcoal in 1,000 mL of a magnesium hydroxide immersion solution for 30 min to 60 min, wherein the magnesium hydroxide immersion solution is prepared by mixing ammonia water with a magnesium chloride solution;
step B, adding 20 g to 50 g of γ-aminopropyltriethoxysilane, conducting ultrasonic vibration for 60 min to 120 min to obtain a mixture, subjecting the mixture to separation, and drying at a temperature of 20° C. to 40° C.; and
step C, mixing a resulting dried biomass charcoal and expanded graphite at a weight ratio of (10-15):1, and conducting ultrasonic vibration for 30 min to 60 min to obtain the modified biomass charcoal powder.

10. The method for preparing the flame-retardant and fire-resistant silicone tape according to claim 9, wherein in step A, the magnesium chloride solution has a concentration of 1 mol/L to 1.5 mol/L, the ammonia water has a concentration of 26 wt %, and a volume ratio of the magnesium chloride solution to the ammonia water is in a range of 100:(1-10).

11. The method for preparing the flame-retardant and fire-resistant silicone tape according to claim 9, wherein the biomass charcoal has a particle size of 10 meshes to 100 meshes, and the expanded graphite has a particle size of 200 meshes to 300 meshes.

12. The method for preparing the flame-retardant and fire-resistant silicone tape according to claim 7, wherein the fumed silica has a particle size of 25 nm to 35 nm and a specific surface area of 230 m²/g.

13. The method for preparing the flame-retardant and fire-resistant silicone tape according to claim 7, wherein the vulcanizing agent is a platinum vulcanizing agent.
